(19) United States
(12) Patent Application Publication
(10) Pub. No.: US 2014/0214507 A1
(43) Pub. Date: Jul. 31, 2014

(54) REFERRAL AFFILIATE BUYOUT SYSTEM AND METHOD

(71) Applicant: VS Media, Inc., Calabasas, CA (US)

(72) Inventor: Bradley Jay Estes, Woodland Hills, CA (US)

(73) Assignee: VS Media, Inc., Calabasas, CA (US)

(21) Appl. No.: 14/160,325

(22) Filed: Jan. 21, 2014

Related U.S. Application Data
(60) Provisional application No. 61/757,649, filed on Jan. 28, 2013.

(51) Int. Cl. G06Q 30/02

(52) U.S. Cl. CPC G06Q 30/0214
USPC 705/14.16

(57) ABSTRACT

A system is connected for communication over a communication network with a plurality of provider entity processors for managing referral fees. The system includes a processor configured to store information associated with referral fee rights including rights of a first provider entity to receive referral fees for referral fee generating activities performed by one or more users that have been referred by the first provider entity to one or more second provider entities. The processor receives a request from the first provider entity to sell defined referral fee rights. The processor calculates a buy-out price associated with the defined referral fee rights and communicates the calculated price to the first provider entity. The processor receives information from the provider entity regarding whether or not the provider entity accepts the calculated buy-out price.

### CROSS-REFERENCE TO RELATED PATENT APPLICATIONS

This application claims priority from Provisional U.S. Application 61/757,649, filed Jan. 28, 2013, incorporated herein by reference in its entirety.

### BACKGROUND

1. Field of the Invention

The present invention relates to systems and methods for referring users to a product or service and, in particular embodiments, for such systems and methods for providing, receiving and managing user referrals on an electronic communication network and for allowing the referral source to sell referral benefits.

2. Related Art

Traditionally, referrals have been a significant source of customers, including new customers, for many entities that sell or otherwise provide products or services. In a typical referral situation, a person seeking a product or service receives a referral in the form of a recommendation (or other information) leading the person to a particular company (or other entity) that provides the desired product or service.

Referrals can come from a variety of sources, including personnel at a related businesses (such as an automobile mechanic who refers a customer to a particular tire store), competitor businesses, referral services, friends, family and other sources. Referrals can come in a variety of different forms, including testimonials from previous customers or users of the product or service, identification information (e.g., name, address, telephone number, website address, etc.) identifying one or more entities that provide a desired product or service, links to on-line network sites that provide or relate to a desired product or service, etc.).

A common mode of making referrals on a communications network is by providing referral information on a website. Such referral information may refer users to one or more other websites for a particular product or service. Thus, for example, an entity operating a first website that provides products or services in the form of movies, video content, audio content or the like, may include a link or other information on its website, referring users to a second website that provides related products or services (e.g., additional movies or content, movie memorabilia, critic analysis, rating information, audio/video playing hardware or software, etc.). The first and second websites may be operated by two different entities. In other contexts, the same entity may operate both websites. In either situation, a user on the first website may read, see or hear information on the first website that refers the user to the second website, where the user may access, order or purchase a particular product or service.

Tracking systems have been developed for tracking user referrals from one website (e.g., a first website) to another (e.g., a second website). Some tracking systems electronically record the number of users that connect to the second website, from the first website. In some contexts, such tracking systems electronically record information associated with the user's purchases and/or other activities on the second website, so that the entity operating the first website can be rewarded for referring the customer to the second website.

Affiliate programs employ tracking systems for rewarding referral sources (also called affiliates) for referring customers. An affiliate program provided by a company (or other entity) can provide a reward to another company (or other entity) for the referral of a customer. For example, a company A (or other entity A) having an affiliate program may provide software or the like to another company B (or other entity B), where the software of the like helps or allows that company B (entity B) to add a link onto that company B's (entity B's) website. The link allows users on a website of company A (entity A) to connect to a website of company B (entity B). In addition, tracking software or the like monitors the user's activities on the website of company B (entity B) including, for example, monitoring any purchases by the user of products or services through the website of company B (entity B).

The affiliate program further provides a shared revenue arrangement, to share with company A (entity A) a defined percentage of revenue received by company B (entity B) from any qualified purchases that the referred user makes through the website of company B (entity B). In this manner, company A (entity A) is rewarded for referring a user to the website of company B (entity B), when the user purchases a product or service through the website of company B (entity B).

Typical affiliate programs allow the referring entity (company/entity A, in the above example) to continue to receive rewards, as referral users continue to return to the purchase products or services from the referred entities (e.g., in later visits to the website of company/entity B). In other words, once a user has been referred to company B (entity B) by company A (entity A), any future qualified purchases made by that user from company B (entity B) are subject to the revenue sharing arrangement of the affiliate program. Thus, under the affiliate program, company B (entity B) may be required to track and share revenue with company A (entity A), well after (e.g., days, months or years after) the user was initially referred to company B (entity B). This can result in a long term commitment and legal obligation of company B (entity B) to company A (entity A).

### BRIEF DESCRIPTION OF THE DRAWINGS

FIG. 1 is a generalized diagram of a network on which a system according to an embodiment of the present disclosure operates.

FIG. 2 is a generalized diagram showing a provider entity's menu page, according to an embodiment of the present disclosure.

FIG. 3 is a generalized diagram showing another provider entity's menu page, according to an embodiment of the present disclosure.

FIG. 4 is a generalized diagram showing a registration page for registering provider entities with a referral management system MS, according to an embodiment of the present disclosure.

FIG. 5 is a generalized diagram showing an account page for a provider entity registered with the referral management systems MS, according to an embodiment of the present disclosure.

FIG. 6 is a generalized diagram showing a buy-out page for a provider entity registered with the referral management system MS, according to an embodiment of the present disclosure.

FIG. 7 is a flow diagram of a buy-out process carried out by a provider entity, according to an embodiment of the present disclosure.

FIG. 8 is a flow diagram of a buy-out process carried out by a referral management system MS, according to an embodiment of the present disclosure.

### DETAILED DESCRIPTION OF THE EMBODIMENTS

In the following description of preferred embodiments, reference is made to the accompanying drawings which form a part hereof and in which are shown by way of illustration specific embodiments in which the invention may be practiced. It is to be understood that other embodiments may be utilized and structural changes may be made without departing from the scope of the preferred embodiments of the present disclosure.

Embodiments of the present invention relate to systems and processes for providing and managing referral programs. Electronic network embodiments of the present invention include or operate with one or more electronic processing devices, such as a computer, connected for communication on an electronic communication network. However, other embodiments of the present invention relate to referral programs operated in any suitable manner, whether or not on an electronic communication network.

According to embodiments of the present invention, a system and process is configured to manage referral fee arrangements for entities that refer users (such as, but not limited to customers) to other entities. For example, a first entity may refer a user (such as a customer) to a second entity, to purchase or otherwise obtain a product or service. If the referred user (or customer) makes a purchase of (or otherwise obtains) a product or service from the second entity, and the second entity receives payment from the referred user for such product or service, then the second entity pays a referral fee to the first entity (such as, but not limited to, a pre-defined fee amount or a pre-defined share or portion of the payment received by the second entity from the referred user), as compensation for referring the user (or customer).

According to particular embodiments of the present invention, a record is made of referrals of users from one entity to another, such that, once a particular user (or customer) is referred by the first entity to the second entity, then all purchases made by that user (or customer) on or after the time of the referral are subject to the referral fee arrangement. Thus, each time a referred user (or customer) visits or returns to purchase products or services from the second entity, the purchases made by that user (or customer) are subject to the referral fee arrangement (even if the user/customer returns well after the initial referral date or visit).

In this manner, over a period of time, the first entity may develop a roster of multiple referrals or referred users (users/customers, including returning users/customers, that the first entity referred to the second entity) and receives referral fees from the second entity for any sales made by second entity to the referred user (or customer). In addition, because the second entity is able to obtain users (or customers) referred from the first entity, the second entity may be able to increase its sales or user (customer) base. Accordingly, referral arrangements can be beneficial to both the referring entity and the entity to which the user (or customer) is referred.

Embodiments of the present invention relate to computerized systems and processes for managing referral arrangements. According to embodiments of the present invention, the first entity (the referring entity—the entity that refers the customer to the second entity) may develop an electronic record or roster of one or more referral users (or customers) that it has referred to the second entity. As part of the system or process, the first entity receives a referral fee for any purchases made by that referred user (or customer) from the second entity, each time that referred user (or customer) makes a purchase from the second entity (or conducts another pre-defined referral fee generating action) after the referral. The amount of the referral fee can be a pre-designated percentage of the purchase price paid by the referred user (or customer) for each purchase made from the second entity, or a predefined amount (e.g., a fixed fee amount, a scaled fee based on number of purchases, length of time from the referral or other factors, or a combination thereof). Thus, each time that referred user (or customer) goes to or returns to (visits again) the second entity and makes a purchase from the second entity, a referral fee is paid by the second entity to the first entity. In this manner, over a period of time, the first entity may receive monetary payments, as its referred users (or customers) make purchases from the second entity.

However, embodiments of the present invention also provide a system and procedure for the first entity to sell (and the second entity or a third entity to acquire) the referral fee rights and, thus, immediately monetize its rights to receive future referral fees for purchases or other activities of one or more of the referral users (customers) on the first entity's roster. Upon selling the referral fee rights for a particular customer (or group of customers), the first entity will obtain a monetary amount for the sale, but will no longer receive referral fees for future purchases made by that customer (or those customers), after the sale of the referral fee rights.

According to further embodiments of the present invention, a sale price for referral fee rights is calculated for a given customer (or group of customers), based on sales records and other information maintained in one or more databases. In particular embodiments, the database(s) store information relating to one or more of past purchases made by each referral customer, past purchases made by related or similar customers, or other suitable information. Based on that information, a calculation is made, for example, using a predefined algorithm, to determine a sale price (buy-out price) for the referral fee rights associated with a customer (or group of customers). That calculated price is communicated to the first entity. Authorized personnel associated with the first entity can, then, determine whether or not to accept the calculated price as the sale price (buy-out price) for the referral fee rights.

If the sale price (buy-out price) is accepted, then records are made of the sale, the calculated amount is paid to the first entity and, thereafter, the second entity no longer pays the first entity referral fees for purchases made by those customers. In particular embodiments, the sale price (buy-out price) is paid by the second entity to the first entity. In other embodiments, the sale price (buy-out price) is paid by a third entity, in return for the third entity taking over the right to receive referral fees for any further purchases made by the customer (or group of customers) from the second entity.

### Electronic Network System Environment:

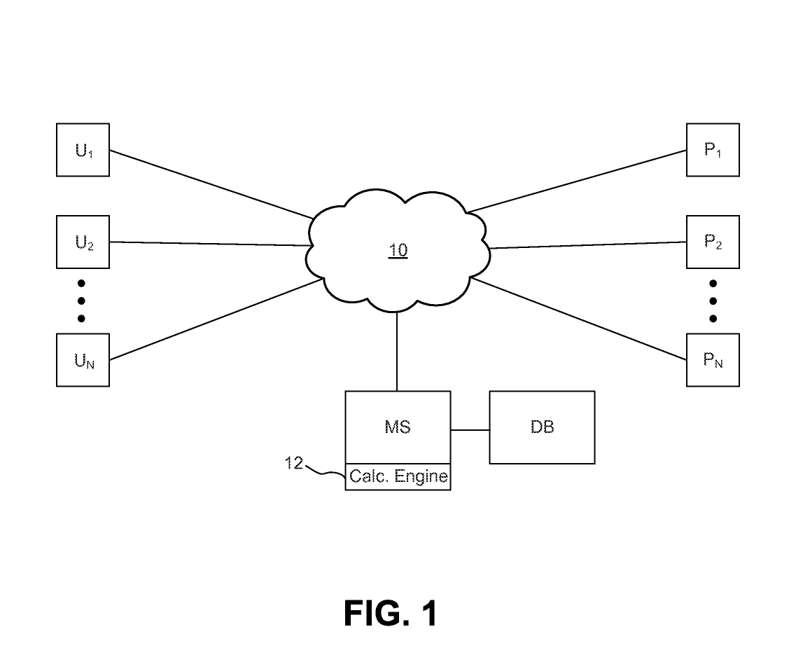

A system according to an electronic network embodiment of the present invention operates with one or more electronic communication networks, such as, but not limited to, wide area networks including the Internet, Intranets, local area networks, combinations thereof, or the like. In the example shown in FIG. 1, a communication network 10 (such as the Internet) provides a communication link between a plurality of communication devices or computers connected to the network. The communication devices or computers are programmed or otherwise configured to provide communication and other operations described herein.

The communication devices or computers in FIG. 1 include a plurality of user devices (represented as U₁, U₂ . . . U_{N}) and a plurality of provider company or provider entity devices (represented as P₁, P₂ . . . P_{N}), each connected for communication over the network 10. A referral management system (MS) is also connected for communication over the network 10. The MS includes or is connected to one or more databases (DB) that stores information that can be accessed and used by the MS. The MS also includes or is connected to one or more calculation engines 12 for calculating proposed buy-out prices, as described herein. In the example described and shown in FIG. 1, any suitable number of users on user devices (U₁, U₂ . . . U_{N}) and any suitable number of provider companies or provider entities on provider devices (P₁, P₂ . . . P_{N}) may be included, from 1 to N, where N represents an integer greater than 1.

The referral management system (MS) includes at least one communication and processing device that is configured to operate as described herein. The communication and processing device may include any suitable network-connectable device capable of operating in the manner described herein, such as, but not limited to one or more, desk top computers, laptop computers, mainframe computers, IPAD™ or other electronic pad devices, phones with data processors, personal digital assistants, or the like. Each database (DB) includes one or more electronic storage device such as, but not limited to a hard drive, read only memory ROM device, or other device for non-transient storage of electronic data. Each calculation engine 12 includes software, hardware, firmware or any combination thereof that operates on one or more electronic processing device to perform calculations described herein.

Each User Device (U_{1-N}) includes a communication and processing device associated with at least one user. The communication and processing device may include any suitable network-connectable device capable of operating in the manner described herein, such as, but not limited to one or more, desk top computers, laptop computers, mainframe computers, IPAD™ or other electronic pad devices, phones with data processors, personal digital assistants, or the like.

Each User Device (U_{1-N}) includes or operates with a suitable electronic display device, for displaying information received over the network 10 to the user associated with the User Device. The display device may include one or more of an electronic display screen for displaying video or still image content, a speaker or other audio producing device for displaying (playing) audible content, a tactile output device for displaying (providing) tactile content, combinations thereof, or the like. In particular embodiments, each User Device (U_{1-N}) includes or operates with suitable media playing software, firmware, hardware, combinations thereof or the like, for playing electronic media content, such as streaming video, streaming audio, streaming tactile signals, other forms of video, audio and/or tactile content, still image content, textual content, combinations thereof, or the like. Each User Device (U_{1-N}) includes one or more input devices for inputting textual information, menu selections, and other information such as, but not limited to a keyboard, touch-screen, electronic writing pad or pen, or the like.

Each User Device (U_{1-N}) includes or operates with suitable network browser software (or other suitable communication software, hardware, firmware or combinations thereof) that allows an associated user to access electronic information content over the network 10. Such software is stored on one or more electronic storage devices included or associated with each User Device (U_{1-N}) such as, but not limited to, a hard drive, read only memory ROM device, random access memory RAM device, or other non-transient electronic storage device.

Each Provider Device (P_{1-N}) includes a communication device associated with at least one provider company or provider entity (referred to, below, as provider entity). The communication device may include any suitable network-connectable device capable of operating in the manner described herein, such as, but not limited to one or more, desk top computers, laptop computers, mainframe computers, IPAD™ or other electronic pad devices, phones with data processors, personal digital assistants, or the like.

Each Provider Device (P_{1-N}) also includes or operates with suitable communication software, hardware, firmware or combinations thereof that allows an associated provider company or provider entity to provide users of User Devices (U_{1-N}) with electronic content such as, but not limited to electronic information, video data, audio data, image data, tactile data, live or pre-recorded or any combination thereof over the network 10. Such software is stored on one or more electronic storage devices included or associated with each Provider Device (P_{1-N}) such as, but not limited to, a hard drive, read only memory ROM device, random access memory RAM device, or other non-transient electronic storage device.

### Referral Management System and Process:

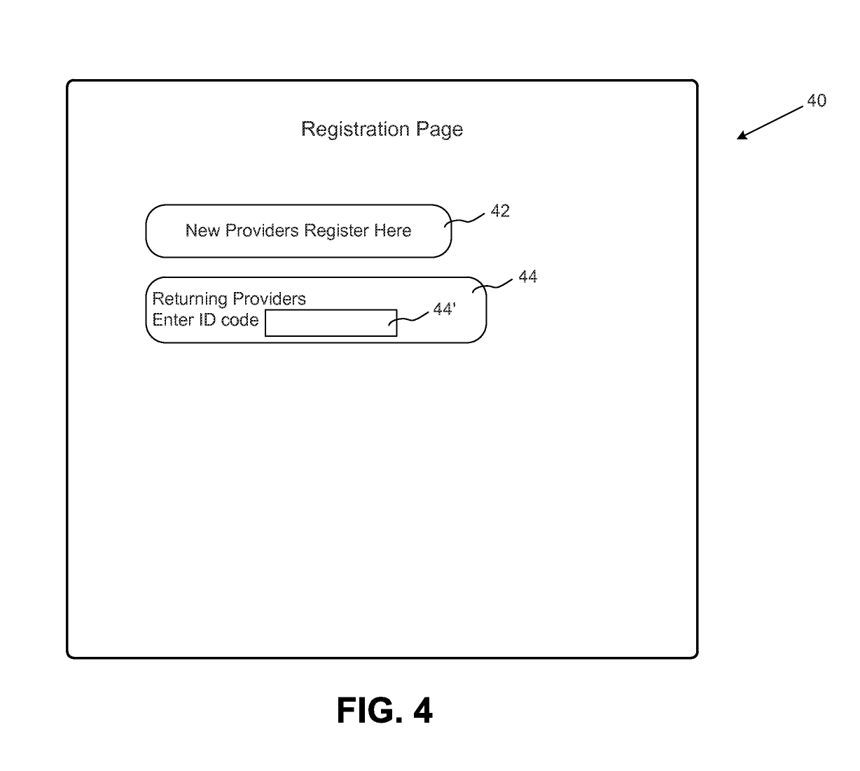

In particular embodiments, the referral management system (MS) provides (or employs one or more other network-connected communication devices to provide) one or more network locations, such as, but not limited to websites that may be accessed (over the network 10) by authorized personnel associated with each provider entity. The provider entity personnel may access the MS network location(s) (or website(s)) through an associated Provider Device (P_{1-N}) or other network-connected communication device. The MS network location(s) (or website(s)) provide an interface for the provider entity personnel to register a provider entity with the MS. Further details regarding the MS network location(s) (or website(s)) are discussed, below, in connection with FIGS. 4-6.

Once a provider entity is registered with the MS, the MS stores and manages records of customer referrals, purchases made by referred customers, referral fees and other information for the registered provider entity. In addition, the MS provides a buy-out mechanism and procedure that calculates a purchase price and allows the provider entity to sell its referral fee rights for the calculated purchase price. Thus, embodiments of the MS allow provider entities operating or associated with one or more Provider Devices (P_{1-N}) to participate in a referral fee arrangement with other provider entities and receive monetary rewards based on purchases made by referred users (or customers) over time. In addition, the MS allows such provider entities to opt to sell their referral fee rights, for example, to immediately receive monetary rewards.

The MS may be operated by or associated with an entity that also operates or is associated with one or more of the provider entities operating or associated with one or more of the Provider Devices (P_{1-N}). In other embodiments, the MS is operated by an entity that is different or independent of the provider entities that operate or are associated with the Provider Devices (P_{1-N}). In further embodiments, the MS operates or is associated with all of the Provider Devices (P_{1-N}) and leases or licenses the Provider Devices (P_{1-N}) and/or network locations (such as, but not limited to websites) to other entities. Such other entities may obtain a lease or license to use the Provider Devices (P_{1-N}) and/or network locations (e.g., websites) for advertising and/or selling products or services and/or providing referral links as described herein.

In particular embodiments, each Provider Device (P_{1-N}) provides (or employs one or more other network-connected communication devices to provide) one or more network locations (such as, but not limited to websites). Such network locations (e.g., websites) are configured to be accessed over the network 10 by users of User Devices (U_{1-N}), for example, to select and purchase or otherwise obtain products or services from the provider entity. In some embodiments, such products or services include electronic data, such as videos, still images, audio clips, tactile data clips, live or pre-recorded, or any combination thereof. In further embodiments, such products or services include physical objects and/or labor services that a user may order through suitable order-taking interfaces (pages, input fields or the like) associated with the provider entities network locations (or websites).

A user may access a provider entity's network location (website or website page) through any suitable manner of connection, including, but not limited to, keying in a network (or website) address through a browser program, selecting an icon for the website on another website page, selecting the website from a list of favorites (favorite sites) predefined by or for the user, or the like. In particular embodiments, a provider entity's network location (e.g., website) includes one or more registration interfaces (e.g., on website pages) that allow each user to employ a registration procedure to open a user account. For example, the registration procedure may require the user to submit certain information (such as, but not limited to, the user's name, title, handle, mailing address, email address, bank account information, credit or debit card information, or the like). Such information can be stored in an account database (not shown) associated with the provider entity's Provider Device (P) and/or can be communicated to (for example, over the network 10) the referral management system (MS) and stored in the database (DB). In some embodiments, the registration procedure also allows the user to purchase or otherwise obtain credits or the like from the MS, for use in paying for products or services from provider entities.

Accordingly, once connected to the provider entity's website, the user is provided with a registration page for display on a display device of the user's User Device (U). Alternatively, the user may be connected with a menu of selectable products or services and, then, be connected to a registration website or page, in response to the user selecting one of the products or services. The registration procedure associates each registered user with a user identification code (such as, a unique identification code). In this manner, upon registration of a user, the provider entity (and/or the referral management system (MS)) is able associate an identification code, a credit balance and/or other account information with the user.

A database is maintained of user account information (including, but not limited to, one or more user identification codes, credit values and other account information) associated with each registered user. Any suitable registration procedures may be employed for registration of users and associating identification codes, credit balances and other account information with registered users, including, but not limited to registration procedures commonly used on a variety of pay-per-view websites and other websites that allow users to purchase or otherwise obtain products or services. Registration information and/or user account information is managed by the provider entity (for example, using the Provider Device (P) or other suitable processing device), the referral management system (MS), or both.

In particular embodiments, to obtain access (or full access) to the selected electronic data or other products or services, the user may be required to submit payment information (for example, through a payment service, such as, but not limited to PayPal™ or the like, or by deducting credits from or recording amounts due in a pre-established electronic account associated with the user). In other embodiments, access to the content or other products or services is provided to the user without requiring payment.

In one example embodiment, a provider entity, using a Provider Device (P) operates or is otherwise associated with a website for users to register to obtain a user account, as discussed above. In other embodiments, the MS operates or is otherwise associated with a website for users to register to obtain a user account (e.g., for use in making purchases from any of the provider entities that have registered as a provider with the MS). Once the user registers, the user may select and access (receive over the network 10) movies, pre-recorded video (or audio/video) clips, or live-video (or audio/video) feeds, for a fee, from a network location operated or associated with the provider entity (or other provider entity that has registered as a provider with the MS). When accessing a provider entity's website, a display device associated with the user's User Device (U) shows one or more website pages that allow the user to select one or more products or services (such as movies or video feeds.

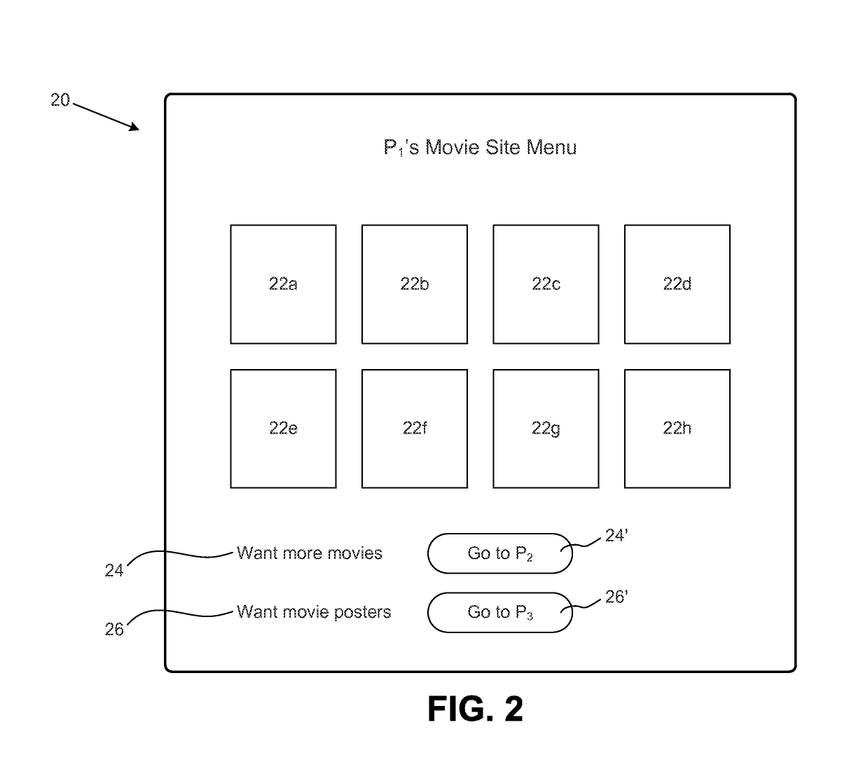

An example of a network location in the form of a website page 20 on a provider entity's website is shown in FIG. 2. The website page 20 shown in FIG. 2 is a menu page that contains a plurality of selectable icons 22a-22h. While FIG. 2 shows eight icons 22a-22h, other embodiments may employ any suitable number of selectable icons (from 1 to N, where N represents any integer greater than 1), each corresponding to a product or service selectable by the user. Also, while the icons 22a-22h are shown in FIG. 2 as being arranged in a grid pattern of rows and columns, other embodiments may employ other suitable arrangements of icons including, but not limited to, lists, tiles, arbitrary orders or the like. Also, in further embodiments, such icons 22a-22h may be displayed as part of a pop-up window, a pull-down menu or other display arrangement on the provider entity's website.

Each icon 22a-22h corresponds to a selectable content item, such as, but not limited to a movie or video feed. In particular embodiments, the icons 22a-22h include artwork, photographs, text, video clips, audio clips or any combination thereof, relating to the movie or video feed to which the icon corresponds. For example, the icons 22a-22h may include a photograph or video clip of an actor or a scene in the corresponding movie or video feed, along with text that identifies the title and/or other information relating to the content item (including, but not limited to, the name of one or more actors, description of the contents or genre, or the like).

Each icon 22a-22h represents a different content item relative to each other icon 22a-22h. In other embodiments, one or more icons 22a-22h represent the same content item. In particular embodiments, each icon 22a-22h includes a selectable link that can be selected by a user, to link the user to an electronic data source (such as another network location or electronic data storage device) at which the user is able to access (download, receive a data stream or otherwise obtain) the selected content item. By selecting a link, the user's User Device (U) is connected to a network address (such as, but not limited to a URL address) for the data source associated with the link. The link can be selected by a user by, for example, but not limited to, placing a cursor over a link icon and activating (clicking) a mouse button or designated keyboard key, or by touching the icon or other designated location on a touch screen display. As discussed above, in particular embodiments, the user may be directed to a payment service to submit a payment (or may be required to submit another form of payment, such as, but not limited to authorizing a deduction of credits or other payment from the user's account), before the user is provided with access (or full access) to the selected content item or the data source for that content item.

In addition to the content item icons 22a-22h, the website page 20 also includes one or more areas 24 and 26 containing advertisements or other information about other network accessible content (e.g., other network locations, websites or other locations on the same website). While FIG. 2 shows two areas 24 and 26, other embodiments may employ any suitable number of such areas (from 1 to N, where N represents any integer greater than 1). Each area 24 and 26 includes artwork, photographs, text, video clips, audio clips or any combination thereof, relating to the other network accessible content (or other network location or website). In addition, each area 24 and 26 includes a selectable link 24′ and 26′, that can be selected by a user, to link the user to an electronic data source (such as another network location or website). The link can be selected by a user in the same manner discussed above for selecting icons 22a-22h.

According to embodiments of the present invention, each link 24′ and 26′ corresponds to a different website or website page (different from the website or page 20 in FIG. 2), where the user is provided with further information. In one example embodiment, the different websites or pages are operated by (or associated with) a different (second) provider entity (different from the first provider entity that operates or is associated with the website or page 20 in FIG. 2). For example, the user may be allowed to select (or select and access) additional products or services on the different (second) provider entity's website or page, in a manner similar to the manner discussed above with respect to the website page 20 in FIG. 2.

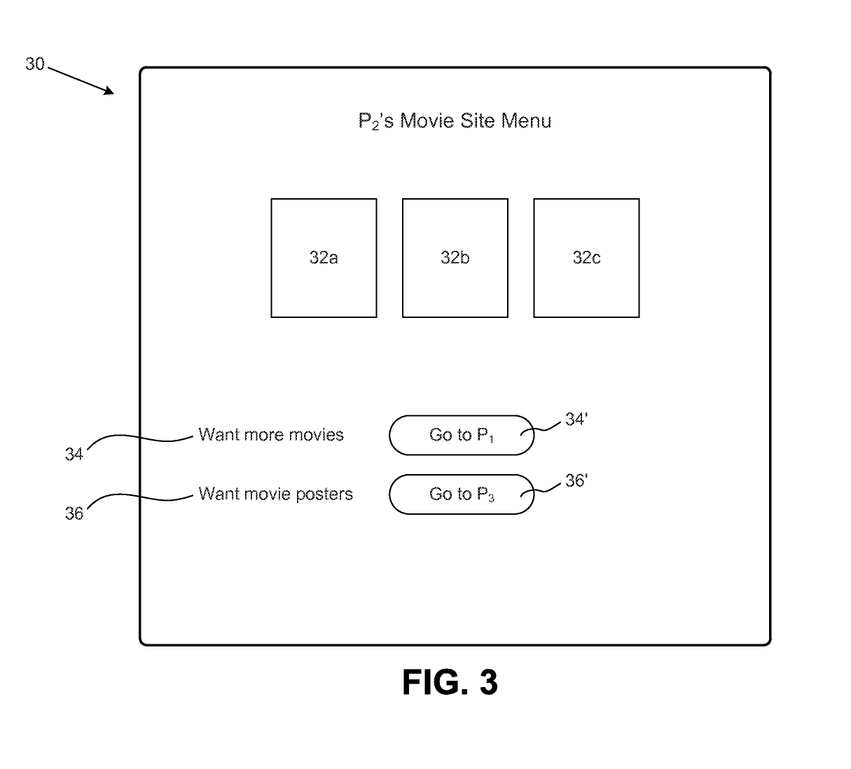

An example of a page 30 of a second provider entity's website is shown in FIG. 3. In the example embodiment, the second provider entity's website page 30 is similar to the first provider entity's website page 20 discussed above. For example, the website page 30 includes a menu of user-selectable icons 32a-32c that are similar to icons 22a-22h, but corresponding to different products or services (e.g., different movies of video feeds) than icons 22a-22h. In other embodiments, some or all of the icons 32a-32c correspond to some of the same products or services included in icons 22a-22h. In addition, the website page 30 also includes one or more areas 34 and 36 containing information about other network accessible content (e.g., other network locations, websites or other locations on the same website) and also containing links 34′ and 36′ to such other network locations and websites, similar to the areas 24 and 26 (and links 24′ and 36′) discussed above.

While FIG. 3 shows three icons 32a-32c and two areas 34 and 36, other embodiments may employ any suitable number of such icons and areas (from 1 to N, where N represents any integer greater than 1). While the arrangement of icons 32a-32c and areas 34 and 36 in FIG. 3 is similar to the arrangement of icons 22a-22h and areas 24 and 26 in FIG. 2, in other embodiments, the arrangement of selectable icons and areas on the second provider entity's website page 30 (FIG. 3) can be different than the arrangement on the first provider entity's website page 20 (FIG. 2).

Thus, with reference to FIGS. 2 and 3, a user accessing a first provider entity's website 20 (FIG. 2) may decide to go to the second provider entity's website 30 (FIG. 3) for additional selections of products or services, by simply activating (for example, clicking on) the link 24′ on the website page 20. By activating (for example, clicking on) the link 24′ from the website page 20 displayed on a display device associated with a user's User Device (U), that User Device (U) is linked and connected to receive information to display the second website page 30 on the display device. Accordingly, the user is able to view and select menu items (icons 22a-22h) on a first website page 20 and, if desired, can activate the link 24′ to view and select additional menu items (icons 32a-32c) available on the second website page 30.

Upon activating a link 24′ or 26′ on the first website page 20, to link to the second website page 30, the user becomes a referred user (or referral user). In addition, that referred user's identification code (or other information identifying the user or that user's account) is provided to the Provider Device (P₂) associated with the second provider entity, the referral management system (MS), or both. In addition, a record (information or the like) that the user was referred to the second website page 30 (or second provider entity) by the first website page 20 (or first provider entity) is recorded. Such record (information or the like) may be recorded in a data storage device associated with the first Provider Device (P₁), a data storage device associated with the second Provider Device (P₂), the database (DB) associated with the referral management system (MS), or any combination thereof.

In this manner, the Provider Device (P₁), the Provider Device (P₂), the referral management system (MS), or any combination thereof, maintains a referral record, showing that the user has been referred to the second provider entity's website by (or from) the first provider entity's website. As the user purchases (or otherwise obtains) products or services on the second provider entity's website, the referral record is updated with additional data to show that the referred user purchased (or otherwise obtained) certain products or services through the second provider entity's website. The referral record is periodically checked (for example by personnel associated with the Provider Device (P₁), the Provider Device (P₂), the referral management system (MS), or any combination thereof) to reconcile referral fees. For example, pursuant to a predefined arrangement between the Provider Device (P₁) and the Provider Device (P₂), the second provider entity may share a portion of the fees received from the user with the first provider entity (as a referral fee for referring the user to the second provider entity's website).

An example of a referral action is described with reference to the website pages 20 and 30 in FIGS. 2 and 3, respectively. In this example, a first user on User Device (U₁) accesses the first website page 20 (provided by or associated with the first provider entity and Provider Device (P₁)) and is able to select one or more of the icons 22a-22h, to obtain products or services associated with those icons. After selecting one or more of the icons 22a-22h to obtain products or services (or without selecting any such icons), the first user selects the icon 24′ to link to the second website page 30. Upon the first user selecting the icon 24′, the User Device (U₁) is linked and connected to receive information to display the second website page 30 (provided by or associated with the second provider entity and Provider Device (P₂)) on the display device.

In addition, data is communicated to the MS from the User Device (U₁), the Provider Device (P₁) and/or the Provider Device (P₂), to allow the MS to make a record that the first user has been referred to the second website page 30 (or the second provider entity) from the first website page 20 (or the first provider entity). The data communicated to the MS includes the first user's identification code (or other information that identifies the first user or the first user's account). The MS records information to indicate that the referral action has occurred, referring that particular first user to the second website page (or to the second provider entity) from the first website page (or from the first provider entity). The MS also records information to indicate a designated referral fee arrangement, such as a specified amount (for example, a percentage of sales price, fixed fee, non-fixed fee, or the like) that is paid by the second provider entity to the first provider entity, in the event that the first user purchases a product or service through the second website page 30 (or from the second provider entity). The MS uses that record to associate calculate (via calculation engine 12) referral fees with the first provider entity, if and when the first user purchases a product or service from the second provider entity.

Once the first user, through User Device (U₁), is linked and connected to receive information to display the second website page 30 (of the second provider entity), the first user may select one or more icons 32a-32c, to purchase (or otherwise obtain) products or services associated with those icons. In addition, data is communicated to the MS from the User Device (U₁) and/or the Provider Device (P₂), to allow the MS to make a record that a purchase was made by the first user from the second website page 30. The data communicated to the MS includes the first user's identification code (or other information that identifies the first user or the first user's account). In particular embodiments, the data also includes the purchase price paid by the first user for the purchase made from the second website page 30 and/or other information relating to the purchase (such as, but not limited to, the type of product or service purchased).

The MS records such data associated with the first user (or the first user's account), where the MS has already recorded information indicating that the first user was referred to the second website page 30 (or to the second provider entity) by the first website page 20 (or first provider entity). Based on that information, the MS calculates a referral fee that is to be paid to the first provider entity by the second provider entity. The referral fee is based on a pre-defined referral arrangement (percentage of sales revenue received by the second provider entity for the first user's purchases, fixed fees, non-fixed fees, or the like) defined by, for example, but not limited to, a referral fee agreement made between the MS and the second provider entity (or between first and second provider entities) during a provider entity registration process or the like.

In particular embodiments, the MS also manages accounts for the first provider entity and the second provider entity, and transfers calculated payments between accounts. Thus, once the MS calculates a referral fee to be paid to the first provider entity by the second provider entity, the MS automatically debits the account of the second provider entity and credits the account of the first provider entity by the calculated amount. In further embodiments, the MS generates and provides statements to each of the registered provider entities, showing debits and credits to the provider entity's account over a predefined payment calculation period (for example, but not limited to, monthly statements, quarterly statements, annual statements, or the like). In further embodiments, instead of or in addition to managing accounts for the provider entities, the MS sends statements (such as invoices) to each of the first and second provider entities (or to another entity that manages provider entity accounts), to show that the second provider entity owes the calculated amount to the first provider entity.

As discussed above, the MS provides one or more network locations (such as, but not limited to, websites) that provider entities (personnel associated with the provider entities) can access to register as a referral provider with the referral management system and process. The provider entity personnel may access the MS network location(s) (or website(s)) through an associated Provider Device (P_{1-N}) or other network-connected communication device. The MS network location(s) (or website(s)) provide an interface for the provider entity personnel to register a provider entity with the MS. In particular embodiments, the MS network location(s) (or websites) also allow each registered provider entity to access their account information, for example, to access information about referral fees being paid to or from the provider entity (or provider entity's account). In addition, the MS network location(s) (or websites) also allow a registered provider entity to sell or offer to sell its referral fee rights.

An example of pages of a network location in the form of website pages provided by the MS for provider entities is shown in FIGS. 4-6. The MS website pages are displayed on a display device associated with the provider entity's Provider Device (P_{1-N}) or other network communication device operated by personnel associated with the provider entity personnel. The MS website can include a registration page on which a provider entity (or personnel associated with the provider entity) can indicate whether it is seeking to register with the referral management system as a new (not previously registered) provider entity, or is a returning provider entity that has previously registered.

An example embodiment of a registration page 40 is shown in FIG. 4. The registration page 40 in FIG. 4 includes a user interface on which a provider entity (or personnel associated with the provider entity) can select a link icon 42 for registering, as a new provider entity, with the referral management system. Alternatively, the provider entity (or personnel) can select a link icon 44 for returning (pre-registered) providers. Icons 42 and 44 are selected by, for example, but not limited to, placing a cursor over the link icon and activating (clicking) a mouse button or designated keyboard key, or by touching the icon or other designated location on a touch screen display.

By selecting the icon 42 for new provider entities, the provider entity (or personnel) is linked (connected) to a further page (not shown) that provides an interface for the provider entity (personnel) to enter information used by the MS to set up a provider account for the provider entity. In particular embodiments, as part of the registration process, the provider entity is associated with an identification code (such as, but not limited to, a unique identification code) that the provider entity (personnel) may use to identify the provider entity in further communications with the MS. In further particular embodiments, as part of the registration process, the provider entity is presented with (or inputs) information for entering into a referral fee agreement with the MS (or with other provider entities registered with the MS). The referral fee agreement defines a procedure for calculating referral fees which may include one or more of a fee (fixed or non-fixed) per referred user, fee (fixed or non-fixed) per purchase or other specified activity of a referred user, a percentage of purchase amounts paid by referred users, or other suitable calculation arrangements.

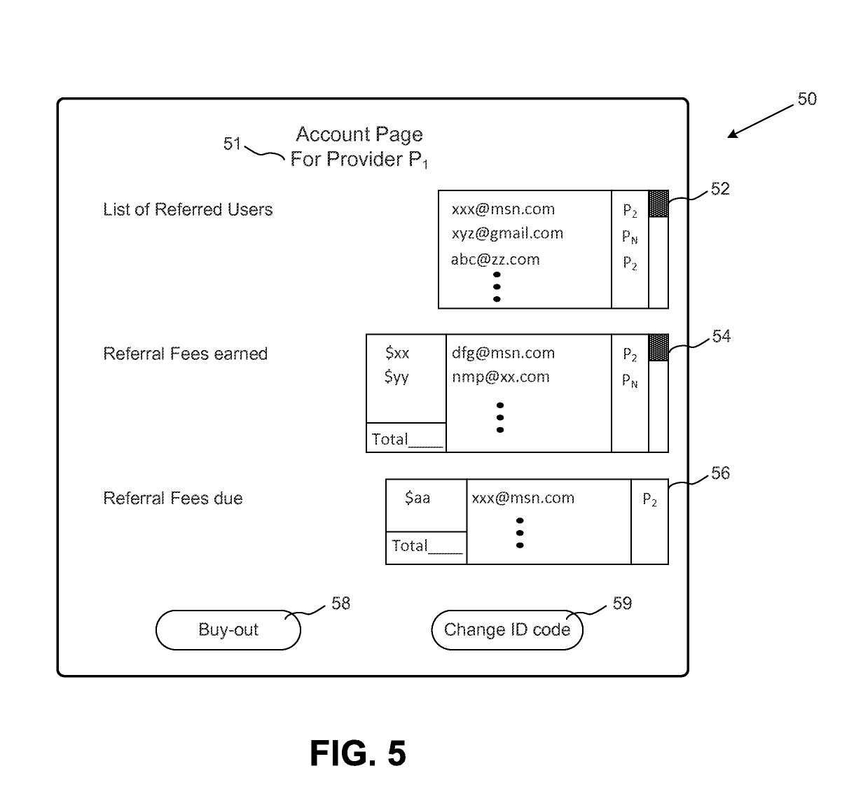

By selecting the Returning Provider icon 44 and/or entering the provider entities identification code in a designated input field 44′, the provider entity (personnel) is linked (connected) to an account page for the provider entity. An example embodiment of an account page 50 for the provider entity associated with Provider Device P₁ (referred to, below, as the first provider entity) is shown in FIG. 5. In the example embodiment, the account page 50 includes text or other indicia 51 that identifies the account page as being associated with the particular provider entity. That text or indicia 51 may include identification information associated with that provider entity, such as, but not limited to the provider entity's identification code, name, handle, logo, service mark or the like. In FIG. 5, the text 51 is “For Provider P₁.” In addition, the account page 50 may include any one or combination of areas 52-58 for displaying information and/or providing links as described below. In further embodiments, other suitable information may be provided on the account page.

The account page 50 in FIG. 5 includes an area 52 in which information is shown about users that have been referred by the first provider entity to other provider entities (e.g., one or more of the other provider entities associated with Provider Devices P₂-P_{N}). The referred users may be users that have selected a link icon 24′ or 26′ from the website page 20 shown in FIG. 2 or that have otherwise been referred by the first provider entity to another provider entity. The area 52 is identified with text or other indicia that describes the nature of the information in the area, such as, but not limited to the text “List of Referred Users”).

The area 52 also includes a list of referred users, i.e., users of one or more of the User Devices (U₁-U₁) who the first provider entity has already referred to one or more of other registered provider entities associated with one or more Provider Devices (P₁-P_{N}). The list of referred users in area 52 may include users (referred users) that have been referred by the first provider entity to one or more other provider entities at any time after the first provider entity initially registered with the referral management service MS. In other embodiments, the list of referred users in area 52 may be a subset of such referred users, such as, but not limited to, a list of referred users that have purchased products or services (or conducted another predefined action), or referred users that have been added or that have purchased products or services (or conducted another predefined action) within a predefined number of previous payment calculation periods or other predefined period.

The list of referred users in area 52 may be provided in any suitable form and include any suitable information. In the embodiment of FIG. 5, the list of referred users in area 52 is provided in the form of scrollable list arranged in a defined rectangle space, with a scroll bar on one side that allows the first provider entity (or personnel associated therewith) to scroll up or down the list to view further entries in the list that are not currently shown in the rectangle space. The scroll bar can be controlled in any suitable manner such as, but not limited to, placing a cursor on the scroll bar and activating a roller, button or other operator on a mouse, activating a designated keyboard key or touching a designated location on a touch screen. In other embodiments, other suitable scroll features may be employed to scroll through information in the area 52. In the embodiment of FIG. 5, the information provided for each referred user in the area 52 includes first identification information (such as, but not limited to an email address, name, handle, account code, or the like) associated with the referred user and second identification information (such as, but not limited to an email address, name, handle, account code, or the like) associated with the other provider entity to which the referred user was referred (i.e., one or more provider entities associated with one or more Provider Devices (P₁-P_{N})).

The account page 50 in FIG. 5 includes an area 54 in which information is shown about referral fees earned thus far by the first provider entity (for referrals made to other provider entities) in the current payment calculation period. The area 54 is identified with text or other indicia that describes the nature of the information in the area, such as, but not limited to the text “Referral Fees Earned”). The area 54 may include one or more of a total of referral fees earned, subtotals of referral fees earned for each referred user, identification information associated with each referred user and identification information associated with the other provider entity to which each referred user is referred (where the identification information may be any suitable identification information as described above with respect to information in area 52). In the embodiment of FIG. 5, the referral fees earned in area 54 is provided in the form of scrollable list that operates in a manner similar to the examples described above with respect to the scrollable list in area 52. In area 54, the total of referral fees earned for the current payment calculation period is shown under the subtotals, at the end of the scrollable list. In other embodiments, the total may be shown in another suitable location in or associated with area 54.

The account page 50 in FIG. 5 includes an area 56 in which information is shown about referral fees due thus far by the first provider entity (for referrals made to the first provider entity from other provider entities) in the current payment calculation period. The area 56 is identified with text or other indicia that describes the nature of the information in the area, such as, but not limited to the text “Referral Fees Due”). The area 56 may include one or more of a total of referral fees due, subtotals of referral fees due for each user that was referred to the first provider entity, identification information associated with each user that was referred and identification information associated with the other provider entity that referred the user to the first provider entity (where the identification information may be any suitable identification information as described above with respect to information in area 52). In the embodiment of FIG. 5, the referral fees due in area 56 is provided in the form of scrollable list that operates in a manner similar to the examples described above with respect to the scrollable list in area 52. In area 56, the total of referral fees due for the current payment calculation period is shown under the subtotals, at the end of the scrollable list. In other embodiments, the total may be shown in another suitable location in or associated with area 56.

Information included in areas 52-56 of the account page 50 can be viewed by the provider entity (personnel) associated with the account page 50 (i.e., the first provider entity, in the embodiment of FIG. 5). Such information can provide an indication of the value of the associated provider entity's portfolio of referred users and current earnings and/or debts for recent referred user activities.

The account page 50 in FIG. 5 includes a link icon 58 that allows the provider entity (or personnel) to link (connect) to a buy-out page. The link icon 58 includes text that identifies the icon. In FIG. 5, the text is “Buy-Out.” In other embodiments, other suitable text or other indicia may be employed to identify the link icon 58. Upon activation of the Buy-Out link icon 58, the provider entity (or personnel associated with the provider entity) is linked or connected to a page that provides an interface for the provider entity (personnel) to sell one or more (or all) of that provider entities referral fee rights (rights to future referral fees). The interface on the buy-out page allows the provider entity (personnel) to enter and view information associated with a proposed sell of some or all of the provider entity's referral fee rights.

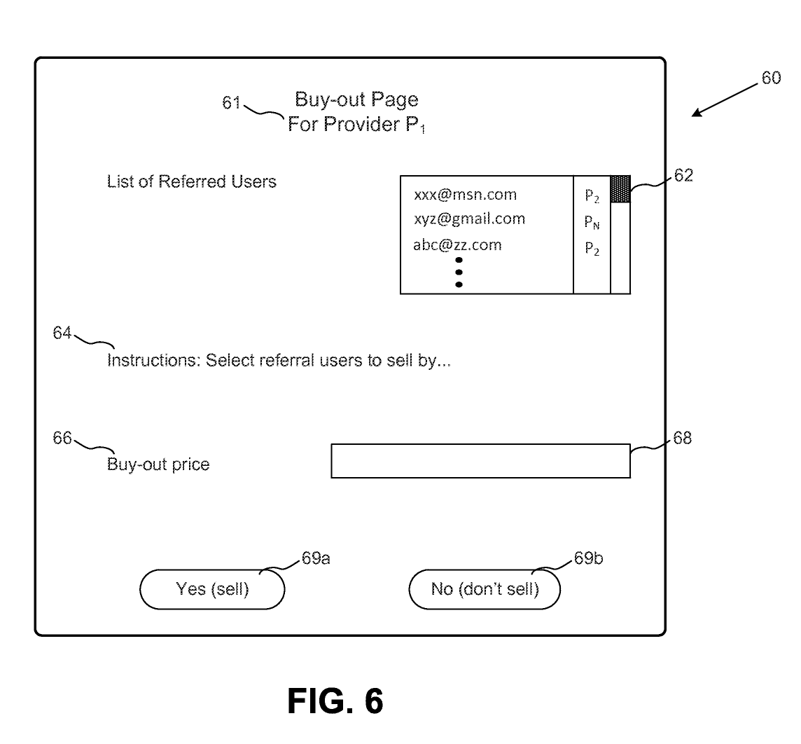

An example embodiment of a buy-out page 60 is shown in FIG. 6. The buy-out page 60 in FIG. 6 includes text or other indicia 61 that identifies the buy-out page as being associated with the particular provider entity. That text or indicia 61 may include identification information associated with that provider entity, such as, but not limited to the provider entity's identification code, name, handle, logo, service mark or the like. In FIG. 6, the text 61 is “For Provider P₁.” The buy-out page 60 also includes any one or combination of areas 62-69b for displaying information and/or providing links as described below. In further embodiments, other suitable information may be provided on the buy-out page.

The buy-out page 60 in FIG. 6 includes an area 62 in which information is shown about the first provider entity's referred users (users that have been referred by the first provider entity to other provider entities) and may be configured as described above with respect to area 52 of the account page 50. In addition, the buy-out page 60 in FIG. 6 includes text 64 describing instructions for selecting individual referred users, groups of referred users and/or all of the referred users in area 62 for a proposed sale of the first provider entities referral rights (rights to future referral fees) associated with the selected referred users or groups.

The provider entity (or personnel associated with the provider entity) may select users, groups of referred users or all of the referred users in the area 62 by any suitable procedure. In one example embodiment, selection is made by aligning a cursor with a referred user's information listed in the area 62 to cause that referred user's information to be highlighted or otherwise displayed in a different manner than other referred users in the area 62 and, then, activating a mouse button or other operator on a mouse or a keyboard key. In another example embodiment, selection is made by touching the selected referred user's information on in the area 62, using a touchscreen display. The selected referred user's information may be displayed in the display area 62 in a manner different from the display of other (non-selected) referred user information, such as by highlighting the selected referred user's information, by employing a different color text for the selected referred user's information, or the like. In further embodiments, the selected referred user's information is displayed in another designated area (not shown) on the buy-out page or related website page or location.

In particular embodiments, the provider entity (or personnel) may select users within the area 62 on an individual (user-by-user) basis by selecting the information associated with a given user. In further embodiments, the website page 60 includes a further interface (such as a selectable icon or the like) that can be operated by the provider entity (personnel) to select all of the referred users in the area 62.

Once the provider entity (or personnel associated with the provider entity) selects one or more referred user's information in the area 62, the MS calculates a proposed sale (or buy-out) price for the sale of the provider entity's referral fee rights (rights to future referral fees for purchase made by the referred users) for the one or more referred users associated with the selected referred user's information. In an example embodiment, the calculation engine 12 of or associated with the MS includes software, hardware, firmware or any combination thereof) configured to calculate a proposed sale (or buy-out) price, based, at least in part, on a predefined algorithm.

In particular embodiments, the calculation (or algorithm used in the calculation) of a proposed sale price is based, at least in part, on information collected by the MS and stored in the DB over a period of time. According to embodiments of the present invention, such information includes historical purchase information for the referred users associated with the selected referred user information (e.g., records of products purchased, amounts paid, number of purchases or other information about each referred user's past activities on websites operated by or associated with provider entities, the MS and/or third parties). Historical purchase information may include, for example, the number of previous purchases made, sales revenue amounts of previous purchases made, and/or types of products or services previously purchased by the referred users associated with the selected referred user information.

Thus, in particular embodiments, the calculation (or calculation algorithm) provides a higher sales (buy-out) price for referral fee rights in referred users that have a history of pervious purchases (for example, a higher number of previous purchases or higher sales revenue amounts of previous purchases). The calculation (or calculation algorithm), in particular embodiments, provides a higher sales (buy-out) price for referral fee rights in referred users that have a history of previous purchases of certain types of products or services (such as products or services with relatively high profit margins). Other factors may be included in the calculation (or calculation algorithm) including, but not limited to, the type of accounts that the referred users have, the amounts of credits or monetary values in the referred users' accounts, whether or not the referred users have a history of returning to a registered provider entities website or of purchasing products or services from a registered provider entity provider entity, the frequency of purchases made by referred users associated with the selected referred user information (for example, where the sales price is higher for referral users that have a higher frequency of purchases), the number or frequency of purchases made by the selected referred user in a predefined period of time, any of the above information associated with similar users (e.g., users similar to the selected referred users that are subject to the proposed sale of referral rights), similar information associated with other users (customers) of the same provider entity seeking to sell referral fee rights, amounts already paid to or by the same provider entity for previous referred users, the number of referred users that have been the subject of previous buy-out sales from the same provider entity, the total amount of payment received by the same provider entity for previous buy-out sales, a predefined (e.g., target) amount that the MS or other purchasing entity has set for spending on referral fee right acquisitions over a predefined period (such as, but not limited to a month, quarter, year or the like), or other suitable factors. A price calculating process can include one or more (or all) of the above-listed factors, each multiplied by a predefined weight factor.

Once a proposed sale (buy-out) price is calculated, the MS provides the proposed sale price for display in an area 66 of the Buy-Out page 60. The proposed sale (buy-out) price may be accepted or rejected by the provider entity (personnel associated with the provider entity). In particular embodiments, the Buy-Out page 60 includes an interface for allowing the provider entity (personnel) to communicate an acceptance or a rejection to the MS. In the embodiment of FIG. 6, the interface includes two areas of the Buy-Out page 60, including an area 69a designated for an acceptance of the proposed sale (buy-out) price and an area 69b designated for a rejection of the proposed sale (buy-out) price. Areas 69a and 69b may include text or other indicia to identify the areas as being associated with sending an acceptance or a rejection message, respectively. In the embodiment of FIG. 6, the acceptance area 69a includes the text “Yes (sell)” and the rejection area 69b includes the text “No (don't sell).” In other embodiments, other suitable text or indicia may be included or associated with the areas 69a and 69b.

The provider entity (personnel) may select one of the areas 69a or 69b to communicate a response to the proposed sale (buy-out) price displayed in the area 66. The provider entity may select one of the areas 69a or 69b by any suitable procedure including, but not limited to placing a cursor over one of the areas 69a or 69b and activating (clicking) a mouse button or designated keyboard key, or by touching one of the areas 69a or 69b on a touch screen display or the like. By selecting area 69b, the provider entity (personnel) communicates a rejection message to the MS, indicating that the provider entity does not accept (i.e., rejects) the proposed sale (buy-out) price. In that event, the provider entity (personnel) may opt to select another group of its referred users (identified in area 62) or, in further embodiments, may be connected (linked) to another website page, such as, but not limited the provider entity's account page 50 (FIG. 5).

By selecting area 69a, the provider entity (personnel) communicates an acceptance message to the MS, indicating that the provider entity would like to accept the proposed sale (buy-out) price for the sale of that provider entity's referral fee rights (rights to future referral fees) for the referral users that the provider entity (personnel) had selected to sell. Upon an acceptance of the proposed sale (buy-out) price, a sale of referral fee rights is performed in any suitable manner. For example, a sale can be accomplished by the MS processing payment information to adjust the provider entity's account, such as, by adding to provider entity's account credits, monetary amounts or other value amounts, corresponding to the proposed sale (buy-out) price accepted by the provider entity (personnel). In other embodiments, the MS may transfer a payment (for example, a monetary amount corresponding to the proposed sale (buy-out) price) to a bank account associated with the provider entity. The MS may receive bank account information and transferring instructions from the provider entity (personnel), for example, during the process of selling the referral rights (e.g., through a further interface area, not shown, on the Buy-Out page designated for the provider entity personnel to input Bank information), or during the above-described registration process (e.g., through a further interface area, not shown, on the Registration page).

Once the sale is completed, the first provider entity will no longer be entitled to referral fees for activities associated with the particular referred users that the provider entity (personnel) selected for the sale. In that regard, the other provider entities (or the MS) that, prior to the sale, had been obligated to pay referral fees to the first provider entity for activities associated with those particular selected referred users, are no longer obligated to track or pay referral fees to the first provider entity for those selected referred users. In addition, the first provider entity is able to immediately monetize or otherwise obtain value for referral fee rights (rights to future referral fees) and does not need to await future referral fees (i.e., does not need to wait for the selected referred users to conduct an activity that generates a referral fee).

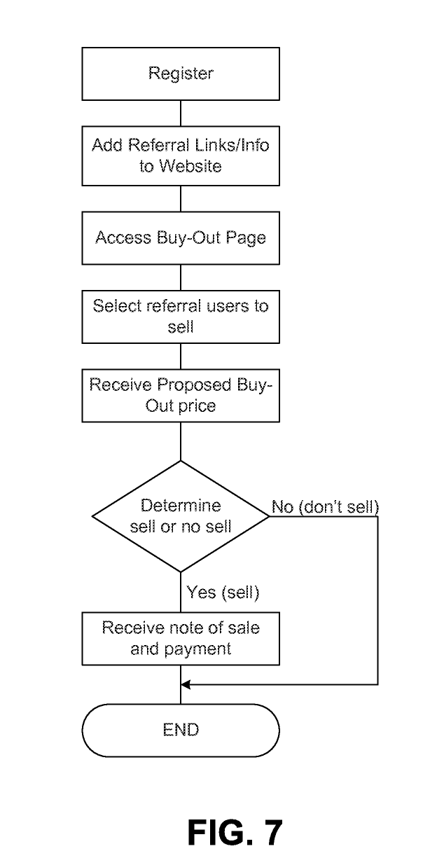

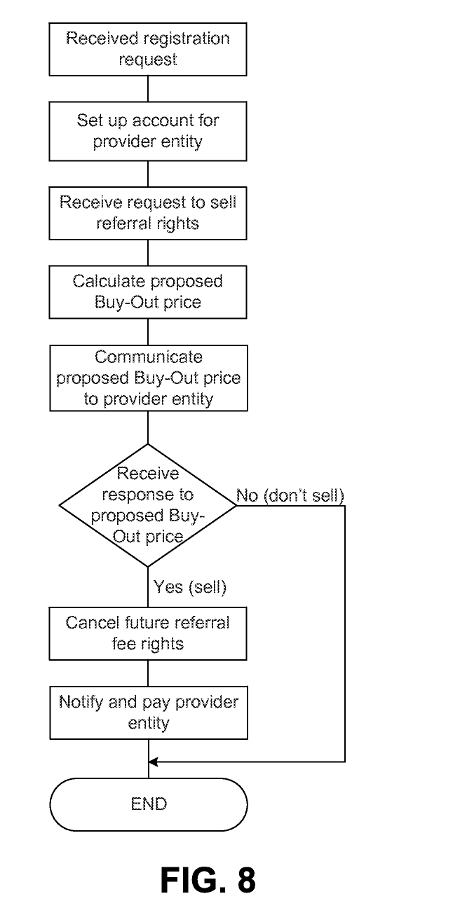

An example of a buy-out process is described with reference to FIGS. 7 and 8, where FIG. 7 shows a flow chart of the example process 700 as carried out by the provider entity (for example, through a Provider Device (P) or other suitable network connected communication device), while FIG. 8 shows a flow chart of the example process 800 as carried out by the MS. In FIG. 7, a provider entity (or personnel associated with the provider entity) initially registers (at 710) with the referral management system MS, for example, as described above with respect to the Registration page 40 in FIG. 4 and associated registration process. As part of the initial registration process, the provider entity is provided with an account.

Once the provider entity is registered (at 710), referral information may be posted or otherwise included (at 720) on one or more network locations, such as websites (or website pages) operated by or otherwise associated with the registered provider entity. An example of referral information posted on a website page is shown at 24, 24′ in FIGS. 2 and 34, 34′ in FIG. 3. The referral information includes at least one of a link icon that includes a link for connecting a user to another network location (e.g., to visit a website operated or associated with another registered provider entity), an advertisement for that other website, other information or indicia that identifies that other website or motivates users to visit that other website, or the like.

In particular embodiments, the referral information (e.g., software for posting and/or displaying the referral information on the provider entity's website) is communicated to the provider entity as part of the registration process. In other embodiments, such referral information is communicated to the provider entity before or after registration. In particular embodiments, the referral information is communicated to the provider entity by the MS (or by another entity), for example, over the communication network 10. In other embodiments, the referral information is communicated to the provider entity by the MS (or by another entity) by other suitable communication means, including, but not limited to, delivery of a non-transient computer readable medium storing such referral information by postal mail, hand delivery, or the like.

Once the referral information is included on the provider entity's network location (e.g., website), user may access that network location (e.g., website) and select the referral link icon (e.g., as discussed above with respect to users selecting icons 24′ and 34′) to link to the other website page associated with the link icon. In particular embodiments, the referral information includes or is associated with software that controls the provider entity's Provider Device (P) to send user visit information to the MS, in response to a user of a User Device (U) selecting the link icon. That visit information includes information that identifies the visiting referred user, such as, but not limited to, that visiting referred user's account code, name, handle or other user identification information. In particular embodiments, the visit information further includes information identifying the provider entity (or provider entity's network location or website) from which the referred user selected the referral link icon, and information identifying the other provider entity (or other provider entity's network location or website) to which the referral user was referred or linked.

In this manner, the MS can receive, store and track visit information regarding which users of User Devices (U_{1-N}) have linked from one registered provider entity's network location (e.g., website) to visit another registered provider entity's network location (e.g., website), as well as which provider entity made the referral (linked the referred user) and which provider entity received the referred user. By receiving such visit information, the MS can determine that one or more particular referred users have been referred by a first provider entity (e.g., operating or associated with Provider Device P₁) to a second provider entity (e.g., operating or associated with Provider Device P₂). In a similar manner, the MS can determine which referred users have been referred to each provider entity, and can also determine which provider entity referred the user.

In addition to user visit information, the MS receives one or more communications of purchase information from the second provider entity, in response to a visiting referred user making a purchase or otherwise obtaining a product or service from the second provider entity. Such purchase information can include, for example, but not limited to the visiting referred user's account code, name, handle or other user identification information, and information about the purchase made by that visiting referred user such as, but not limited to the purchase price paid, the type of product or service purchased, the specific product or service purchased, or the like. By receiving, storing and tracking such purchase information, the MS can determine that one or more particular referred users have made a purchase (or conducted another referral fee generating event) and can determine a referral fee amount for that purchase (or other event).

The referral fee amount may be calculated, based on a pre-arranged referral fee agreement between the provider entity making the referral and the MS (or between the provider entity making the referral and the provider entity receiving the referral). The pre-arranged referral fee agreement may be included as part of the provider entity registration process, described above.

In the above-described embodiment, communications of purchase information are sent from the Provider Device P₂ (or other network connected communication device associated with the second provider entity) to the MS in any suitable manner. In particular embodiments, such communications are sent over the communication network 10, in response to a purchase (or other referral fee generating event) of a referred user. By receiving, storing and tracking such purchase information, the MS can determine that one or more particular users have been referred by a first provider entity (e.g., operating or associated with Provider Device P₁) to a second provider entity (e.g., operating or associated with Provider Device P₂).

The MS determines and calculates referral fee payments to be made to and/or from registered provider entities, based, at least in part, on user visit information and purchase information received by the MS. The referral fee payment calculations are also based, at least in part, on the pre-arranged referral fee agreement between the provider entity making the referral and the MS (or between the provider entity making the referral and the provider entity receiving the referral). In addition, the MS records information associated with referral users and communicates such information to registered provider entities, for example, but not limited to, displaying such information on the Account page 50 (FIG. 6) and/or the Buy-Out page 60 (FIG. 6) associated with each provider entity (such as, but not limited to, the information in areas 52, 54, 56 and/or 62 described above).

With reference to the flow chart of FIG. 7, the provider entity (personnel) may access (at 730) the Buy-Out page 60 and, then, select (at 740) one or more referred users (users that have been referred by the provider entity to another provider entity) to include in a proposed sell of referral rights (rights to future referral fees for activities conducted by the selected one or more referral users). The selection (at 740) of one or more referred users may be accomplished in any suitable manner, including the examples discussed above with respect to the interface area 62 and instruction text 64 on the Buy-Out page 60.

Once the provider entity (personnel) has selected (at 740) one or more referred users to include in the proposed sell of referral rights, the MS calculates a proposed sale price, as discussed above. The proposed sale price is, then, communicated to and received by (at 750) the provider entity (personnel), for example, by the MS displaying text or other indicia representing the proposed sale price in an area 66 of the provider entity's Buy-Out page 60. The provider entity (personnel) determines and communicates to the MS its decision (at 760) of whether or not to accept the proposed sale price, where that decision may be based, for example, on business, personal or other considerations.

In example embodiments described above, the provider entity (personnel) communicates its decision to the MS by selecting one of the sell or don't sell icons 69a or 69b, located on the Buy-Out page 60. If the provider entity communicates a “Yes” or “sell” decision (at 760a), then the MS sends and the provider entity receives notification of the sell and a payment associated with the sell, for example, in the manners discussed above. Thereafter, the process ends. If the provider entity communicates a “No” or “don't sell” decision (at 760b), then the process ends at that point. In further embodiments, additional procedures may be included in the process, including returning the provider entity (personnel) to the Buy-Out page 60 or other website page, after a decision is made and communicated (at 760).

An example of a buy-out process 800 as carried out by the MS is shown in FIG. 8 (and tracks the process 700 carried out by the provider entity in FIG. 7). In FIG. 8, the MS initially registers a provider entity (at 810), for example, as described above with respect to the Registration page 40 in FIG. 4 and associated registration process. As part of the initial registration process, the provider entity is provided with an account.

At 820, the MS receives a request from a registered provider entity to sell one referral rights (rights to future referral fees) associated with one or more referred users (users that the provider entity has referred to other provider entities). The request may be received from a provider entity (personnel), through interfaces associated with the Buy-Out page 60, discussed above. The MS calculates a proposed Buy-Out price (at 830) and communicates the calculated proposed Buy-Out price (at 840) to the provider entity (personnel). The MS may calculate the proposed Buy-Out price in any suitable manner, including, but not limited to those discussed above. The MS may communicate the calculated proposed Buy-Out price to the provider entity in any suitable manner, including, but not limited to displaying text or other indicia representing the proposed Buy-Out price in the area 66 of the provider entity's Buy-Out page 60.

At 850, the MS receives information from the provider entity (personnel), indicating a decision regarding whether or not the proposed Buy-Out price is accepted by the provider entity. In embodiments discussed above, such information may be received by the MS from input entered by the provider entity (personnel) from an interface associated with the icons 69a and 69b on Buy-Out page 60.

If the MS received a communication from the provider entity indicating a “Yes” or “sell” decision (at 850a), then the MS cancels (at 860) future referral fee rights of that provider entity for purchases or other referral fee generating activities of the particular referral fee users selected by the provider entity for the sale. In addition, the MS sends a notification (at 870) of the sell and a payment associated with the sell, for example, in the manners discussed above. Thereafter, the process ends. If the MS received a communication from the provider entity indicating a “No” or “don't sell” decision (at 850b), then the process ends at that point. In further embodiments, additional procedures may be included in the process, including returning the provider entity (personnel) to the Buy-Out page 60 or other website page, after a decision is received (at 850).

In various embodiments described above, provider entities (such as the first provider entity) that refer users to other provider entities are, themselves, entities that sell or otherwise provide products or services. However, in other embodiments, a provider entity (such as the first provider entity) that refers users to other provider entities may be an entity that does not, itself, sell or provide products or services to users but, instead, provides referral links to other provider entities.

In embodiments described above, a provider entity (such as the first provider entity) may opt to sell referral rights in one or more of its referred users (users that the provider entity referred to other provider entities), where the purchaser of those referral rights is the MS or the other provider entity. In yet other embodiments, the purchase of those referral rights may be another provider entity (not previously associated with the referred user) or another entity that is not a provider entity (such as, but not limited to, a third party investor seeking to invest in future referral fee rights). In yet further embodiments, the MS may operate or be associated with a further network location (such as a further website) on network 10 configured to promote, advertise and/or provide an interface for provider entities or third parties to purchase referral fee rights.

In such embodiments, the MS may receive buy-out requests from one or more provider entities, as discussed above, and then list buy-out/purchase opportunities (associated with the requests) on the further website for other provider entities or third parties to view and select for purchase. In such embodiments, the MS may set and list a proposed buy-out price (e.g., based on calculations described above). In other embodiments, the MS may list the buy-out/purchase opportunities and request bids from potential purchases (e.g., over the network 10). Upon receiving a bid, the MS communicates the bid (e.g., over the network 10) to the provider entity that requested the sale. The provider entity may determine whether or not to accept the bid and may communicate information associated with that decision to the MS (e.g., over the network 10). If the bid is accepted, the MS operates to collect payment from the purchasing entity and credits the payment to the selling provider entity's account, for example, in the manner discussed above.

While embodiments described above refer to network locations in the form of websites and website pages, other embodiments may employ other forms of network locations. Also, where embodiments employ different website pages to display information and/or provide interfaces for input of information to the system, other embodiments may employ other display and interface arrangements including, but not limited to different locations on the same or common website page, pop-up windows, pull-down menus or other display and interface configurations.

While particular embodiments of the present disclosure have been shown and described, it will be obvious to those skilled in the art that the present disclosure is not limited to the particular embodiments shown and described and that changes and modifications may be made without departing from the spirit and scope of the appended claims.

What is claimed is:

1. A system connected for communication over a communication network with a plurality of provider entity processors for managing referral fees, the system comprising a management system processor configured to:
store information associated with referral fee rights including rights of a first provider entity to receive referral fees for referral fee generating activities performed by one or more users that have been referred by the first provider entity to one or more second provider entities;
receive a request from the first provider entity to sell defined referral fee rights;
calculate a buy-out price associated with the defined referral fee rights;
communicate the calculated buy-out price to the first provider entity; and
receive information from the provider entity regarding whether or not the provider entity accepts the calculated buy-out price.

2. A system as recited in claim 1, wherein the management system processor is further configured to determine, based at least in part on the stored information, referral fees due to the first provider entity for one or more referral fee generating activities performed by one or more users that have been referred by the first provider entity to a second provider entity.

3. A system as recited in claim 1, wherein the request is received over the communication network.

4. A system as recited in claim 1, wherein the calculated buy-out price is communicated by displaying information that refers to a proposed monetary value on a website page.

5. A system as recited in claim 4, wherein the buy-out price is calculated by calculating a value based, at least in part, on historical purchase information for purchases made by one or more users that have been referred by the first provider entity to one or more second provider entities.

6. A system as recited in claim 4, wherein the buy-out price is calculated by calculating a value based, at least in part, on one or more of a number of products purchased, a type of product purchased, amounts paid, and a number of purchases made by one or more users that have been referred by the first provider entity to one or more second provider entities.

7. A system as recited in claim 1, wherein the buy-out price is calculated by calculating a value based, at least in part, on historical purchase information for purchases made by one or more users that have been referred by the first provider entity to one or more second provider entities.

8. A system as recited in claim 1, wherein the buy-out price is calculated by calculating a value based, at least in part, on one or more of a number of products purchased, a type of product purchased, amounts paid, and a number of purchases made by one or more users that have been referred by the first provider entity to one or more second provider entities.

9. A method of communication over a communication network with a plurality of provider entity processors for managing referral fees, the method comprising:
storing in a non-volatile electronic memory, electronic information associated with referral fee rights including rights of a first provider entity to receive referral fees for referral fee generating activities performed by one or more users that have been referred by the first provider entity to one or more second provider entities;
receiving a request from the first provider entity to sell defined referral fee rights;
calculating, with an electronic processing device, a buy-out price associated with the defined referral fee rights;
communicating, over the communication network, the calculated buy-out price to the first provider entity; and
receiving, over the communication network, information from the provider entity regarding whether or not the provider entity accepts the calculated buy-out price.

10. A method as recited in claim 9, further comprising determining, based at least in part on the stored electronic information, referral fees due to the first provider entity for one or more referral fee generating activities performed by one or more users that have been referred by the first provider entity to a second provider entity.

11. A method as recited in claim 9, wherein receiving a request comprises receiving a request over the communication network.

12. A method as recited in claim 9, wherein communicating the calculated buy-out price comprises displaying information that refers to a proposed monetary value on a website page.

13. A method as recited in claim 12, wherein calculating a buy-out price comprises calculating a value based, at least in part, on historical purchase information for purchases made by one or more users that have been referred by the first provider entity to one or more second provider entities.

14. A method as recited in claim 12, wherein calculating a buy-out price comprises calculating a value based, at least in part, on one or more of a number of products purchased, a type of product purchased, amounts paid, and a number of purchases made by one or more users that have been referred by the first provider entity to one or more second provider entities.

15. A method as recited in claim 1, wherein calculating a buy-out price comprises calculating a value based, at least in part, on historical purchase information for purchases made by one or more users that have been referred by the first provider entity to one or more second provider entities.

16. A method as recited in claim 1, wherein calculating a buy-out price comprises calculating a value based, at least in part, on one or more of a number of products purchased, a type of product purchased, amounts paid, and a number of purchases made by one or more users that have been referred by the first provider entity to one or more second provider entities.
